(19) United States
(12) Patent Application Publication
(10) Pub. No.: US 2011/0013276 A1
(43) Pub. Date: Jan. 20, 2011

(54) THREE DIMENSION LEAFLET FOR ADVERTISING

(76) Inventor: Hae-Yong CHOI, Seoul-city (KR)

Correspondence Address: BACON & THOMAS, PLLC, 625 SLATERS LANE, FOURTH FLOOR, ALEXANDRIA, VA, 22314-1176, US

(21) Appl. No.: 12/640,447

(22) Filed: Dec. 17, 2009

(30) Foreign Application Priority Data
Jul. 20, 2009 (KR) 10-2009-0065724
Oct. 16, 2009 (KR) 10-2009-0098500

(51) Int. Cl. G02B 27/22

(52) U.S. Cl. 359/474; 359/477

(57) ABSTRACT

The present invention relates to a three dimension leaflet for advertising wherein lens plate is movable on a surface of three dimension image so that a several three dimension images are observed, comprising an advertising face on a front surface of the leaflet and a several three dimension image faces on a rear surface thereof wherein left and right images, a middle blocking plate and lens plate are provided on the three dimension image face, so that the leaflet is collapsible to form a thin configuration when it is carried, and focusing distances of the left and right lens are fixed stably by the middle blocking plate when it is used and further the three dimension image is observed obviously through external light.

### BACKGROUND OF THE INVENTION

1. Field of the Invention

The present invention relates to a three dimension leaflet for advertising simultaneously three dimension image and advertising image, and more particularly, to a three dimension leaflet for advertising simultaneously several three dimension images and advertising images on a simple leaflet.

2. Description for the Related Art

Generally, a leaflet refers to an advertising flyer consisting of 1-2 sheets and aims for mass distribution and thus has to be a thin film of single sheet in taking a consideration of packaging, transporting and distribution thereof.

However, refer to a prior leaflet of a pamphlet configuration, several three dimension images are not able to be provided thereon, and further even one three dimension image is provided, the three dimension image is overlapped leftward and rightward to be seen as three images so that clear image is not obtained. Furthermore, a location in which a three dimension image is provided is inside a system wherein outer light is shielded so the image is not shown obviously.

### SUMMARY OF THE INVENTION

In order to solve the aforementioned drawbacks of the prior art, the present invention proposes a three dimension leaflet for advertising.

Referring to a configuration of a three dimension leaflet for advertising, it is important that a several three dimension images are observed.

For example, when only one picture of three dimension image for a three dimension movie leaflet is shown, it does have much advertising effects. That is, when more main pictures are shown, advertising effect is increased. This applies to product catalog at same aspect.

For example, when a leaflet for an automobile is made three dimensionally, front face, rear face, driver's seat inside front window, and rear seat inside the car have to be shown, instead of one picture of the car, in order to increase advertising effects.

The present invention proposes a three dimension leaflet for advertising wherein a several three dimension images are observed on one leaflet, and the three dimension images are not to be collapsed when it is observed, and the three dimension images are observed obviously. Furthermore, the leaflet is to be a thin configuration when it is carried, and focusing distances of left and right lens, and left and right images are to be kept stably.

According to the present invention, a three dimension advertising leaflet for observing a several three dimensional images on one leaflet comprises: a leaflet on front face of which an advertising surface is provided and on rear face of which a plurality of left and right images is provided; and an observation device provided with a lens plate having a middle blocking plate, a bottom support frame and left and right lens, and a movement frame having left and right windows wherein the observation device is movable on surfaces of the left and right images.

Meanwhile, the lens plate, the middle blocking plate, and the bottom support frame are collapsible respectively to form a thin configuration when it is carried.

According to the leaflet of the present invention, as shown in FIGS. 1, 2, 3, 4, 5 and 6, a three dimension image face 1b forming a several three dimension images is provided on a rear surface of the leaflet 100 and a general advertising surface 1a is provided simultaneously on a surface of the leaflet 100 so that three dimension image and general advertising wordings are provided on one three dimension leaflet for advertising, increasing advertising effects. Meanwhile, the movement frame 6 is movable on a surface of the three dimension image face 1a, as shown in FIGS. 4(a) and 6(a), so that a several three dimension images cab be observed.

A configuration of the middle blocking plate 2 provided between left and right lens 4L, 4R, and left and right images 3L, 3R avoids the three dimension images being observed overlappingly. Additionally, the middle blocking plate 2 and the bottom support frame 5 are collapsed in a sequence, as shown in FIGS. 4(a), 4(b), 4(c), 6(a), 6(b), and 6(c), to form a thin configuration when it is carried, enabling a three dimension leaflet for advertising.

Furthermore, the three dimension image face 1a is exposed to outer light when three dimension image is observed so that the three dimension image is observed obviously, and further distance between the lens plate 4 and the three dimension image face 1a is fixed by the middle blocking plate 2 so that focus is stable and bright three dimension image can be observed.

### BRIEF DESCRIPTION OF THE DRAWINGS

FIG. 1 shows schematically a shape and configuration of a three dimension leaflet for advertising according to the present invention.

FIG. 2 shows schematically separated configurations of the leaflet and the observation device according to one embodiment of the present invention.

FIG. 3 shows schematically configurations of an advertising face according to the present invention.

FIG. 4(a) shows schematically functions of the observation device being moved up-down and a several three dimension pictures being observed.

FIG. 4(b) shows schematically a middle blocking plate which is collapsed according to the present invention.

FIG. 4(c) shows schematically the three dimension leaflet according to the present invention, when it is collapsed as a thin film.

FIG. 5 shows schematically a leaflet provided with several advertising faces on its rear surface.

FIG. 6(a) shows schematically the observation device being moved up-down according to the first embodiment of the present invention.

FIG. 6(b) shows schematically the observation device being collapsed according to the first embodiment of the present invention.

FIG. 6(c) shows schematically the observation device being collapsed as a thin film according to the first embodiment of the present invention.

### DETAILED DESCRIPTION OF THE PREFERRED EMBODIMENTS

The preferred embodiments of a three dimension leaflet for advertising according to the present invention will be described in detail referring to the accompanied drawings.

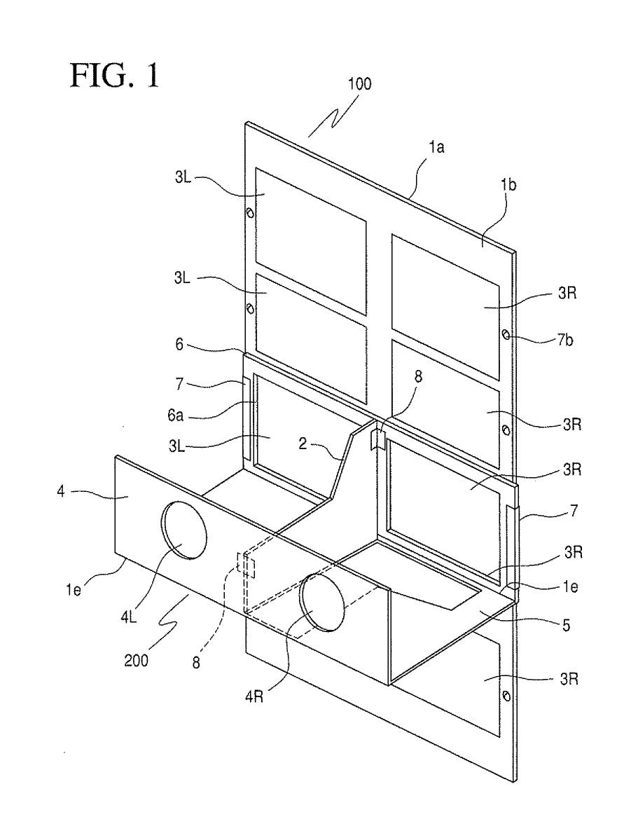

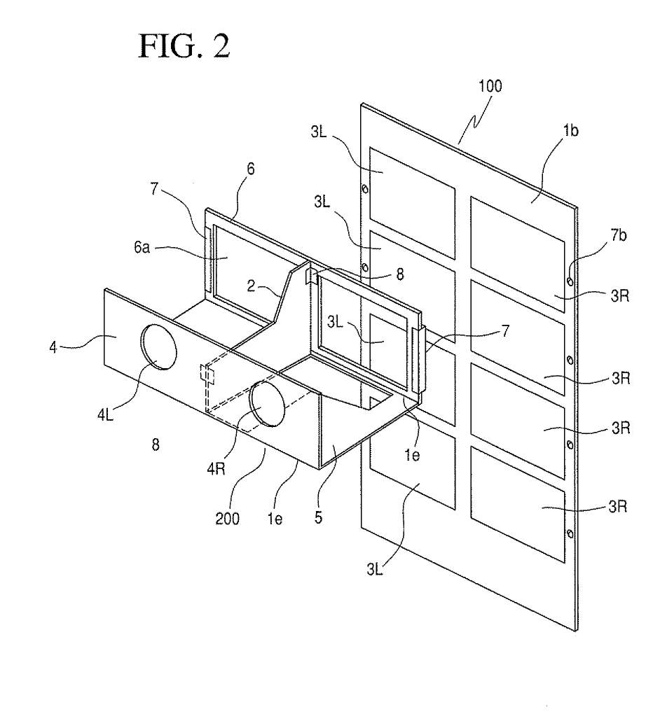

FIG. 1 shows representatively a three dimension leaflet according to the present invention, which is used for advertising, and FIG. 2 shows a leaflet 100 and an observation device 200, which are exploded.

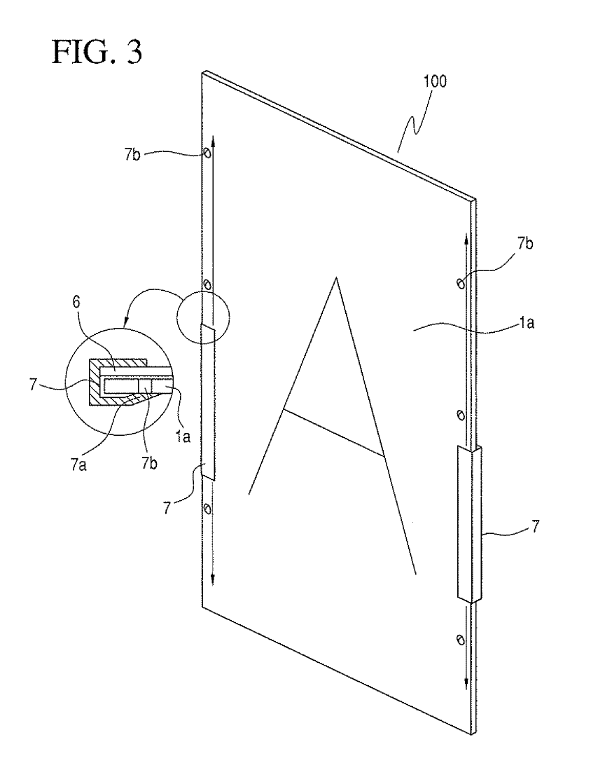

According to one embodiment of the present invention, the leaflet structure 100 and the observation structure 200, which are shown in FIGS. 1 and 2, are provided separately and then the leaflet 100 is inserted into a groove of a fastening unit 7 which is made of elastic material such as rubber, spring and sponge and fixed to the observation device 200, as shown in FIG. 3.

As shown in FIG. 3, a front surface of the leaflet 100 made of paper, plastic, etc., is provided for an advertising surface 1a and a rear surface of the leaflet 100 is provided for a three dimension image surface 1b, as shown in FIG. 2. Here, the three dimension image surface 1b is provided with left image 3L and right image 3R of picture and design, which are placed rightward and leftward, and upward and downward, as shown in FIGS. 1 and 2.

The observation device 200 as shown in FIGS. 1 and 2 includes a movement frame 6 in which a right window 6a and a left window 6b are formed, a bottom support frame 5 provided with a middle blocking plate 2, and a lens plate in which a left lens 4L and a right lens 4R are provided, which are formed in sequence from the paper or plastic of the rear surface of the leaflet 100.

Meanwhile, collapsible lines 1e for the respective elements to be collapsible repeatedly thereon are formed on the respective boundary surfaces of the movement frame 6, the bottom support frame 5 and the lens plate 4.

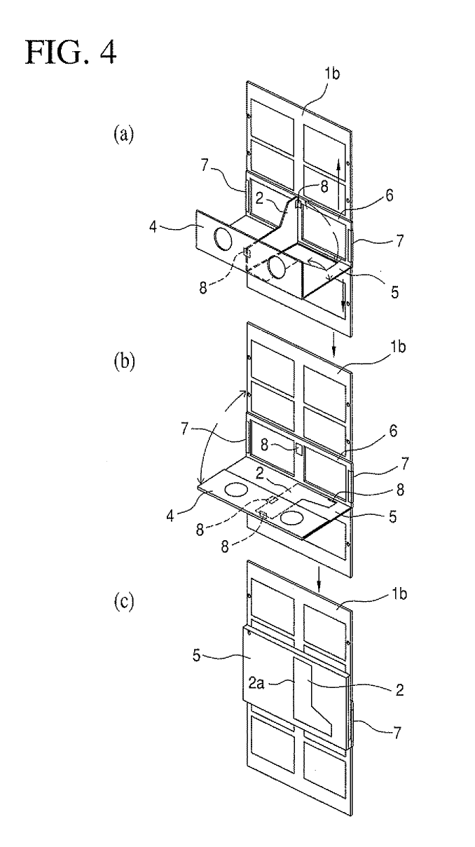

As shown in FIG. 4c, a collapsible line 2a is formed frontward to rearward on a boundary surface between the bottom support frame 5 and the middle blocking plate 2 so that the bottom support frame 5 is rotated upward and downward.

As shown in FIG. 2, a connection device 8 made of magnetic material such as iron is provided between the left and right windows 6a, 6b and the left and right lens 4L, 4R.

Furthermore, collapsible lines 1e are formed on the respective boundary line of the movement frame 6, the bottom support frame 5 and the lens 4.

Additionally, as shown in FIGS. 2 and 3, the configurations of the leaflet 100 and the observation device 200 are connected with the fastening unit 7 wherein the fastening unit 7 made of elastic material such as rubber or spring, as shown exploded in FIG. 3, is fixed to the movement frame 6 and the leaflet 100 is movable upward and downward inside the fastening unit 7 through its elasticity and can be stopped at a desired location, if necessary.

Here, referring to a configuration of the fastening unit 7, the left and right fastening units 7 of the leaflet 100 are connected through a transparent plastic to form a simple fastening unit 7 and further the fastening unit 7 and the movement frame 6 are connected to form a simple construction.

Furthermore, the leaflet 100 is moved upward and downward inside a groove of the fastening unit 7. Additionally, as shown in FIGS. 1, 2 and 3, holes are formed on the respective ends of the left and right images 3L, 3R of the leaflet 100 to form a fixing hole 7b and a protrusion member 7a may be formed on an internal face of the fastening unit 7, as shown in FIG. 3. Under this configuration, the protrusion member 7a may be fastened to the fixing hole 7b on a surface of the fastening unit 7 of the observation device 200 moving on a surface of the leaflet 100 so that the observation device 200 may be stopped stably at a desired location of the left and right images 3L, 3R per image unit.

Accordingly, as shown in FIGS. 1, 2 and 4(a), the observation device 200 is moved on a surface of several three dimension images 1b and the several three dimension images are observed.

Additionally, as shown in FIG. 4(a), the middle blocking plate 2 is rotated upward and downward and then the lens plate 4 and the movement frame 6 are erected symmetrically and connected through the magnetic body of the connection device 8. Here, after use, the middle blocking plate 2 is collapsed upward and downward, as shown in FIG. 4(a), and then the lens plate 4 is collapsed frontward and rearward, as shown in FIG. 4(b), and the bottom support frame 5 is collapsed to form a thin structure, enabling the leaflet to be a thin configuration.

Here, not-indicated reference numerals in FIGS. 4(b) and 4(c) are identical to them in FIG. 4(a). For clarification, operational parts in FIGS. 4(b) and 4(c) are only indicated

Furthermore, the connection device 8 provided with a magnet and magnetic body may be replaced with a sticking tape or a hook, which is detachable easily.

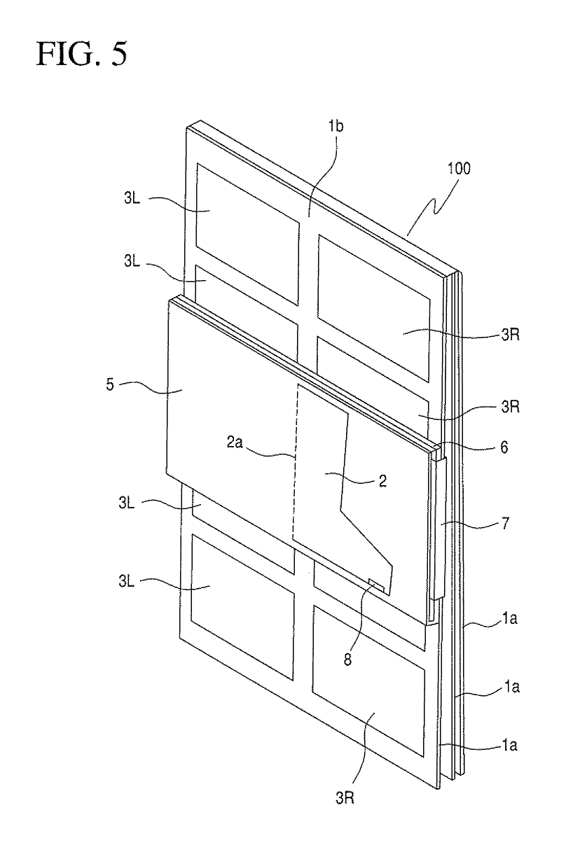

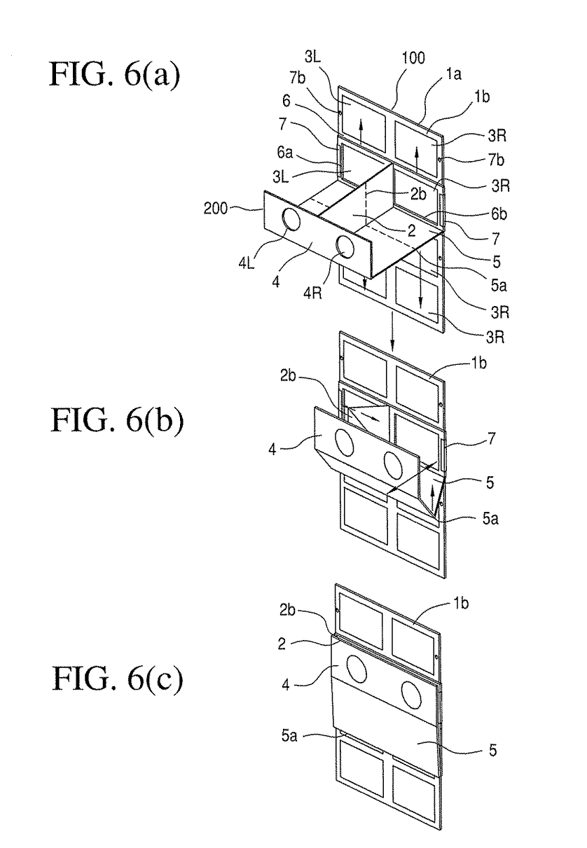

In addition, as shown in FIG. 5, several general advertising faces 1a may be provided additionally to the front or rear surface of the leaflet 100 in FIG. 6 and the configuration in FIG. 1. In summary, the aforementioned observation device 200 of the present invention is configured such that the movement frame 6 and the lens plate 4 are stand erectly on the bottom support plate 5 through the middle blocking plate 2 so that the aforementioned members are supported firmly and the observation device 200 is movable on surfaces of a several three dimension images 1b, as shown in FIG. 4(a), causing the several three dimension images are to be observed.

### Embodiment 1

As shown in FIGS. 6(a), 6(b) and 6(c), the leaflet 100 and the observation device 200 are provided separately and then are connected to the fastening unit 7, as shown in FIG. 2.

Here, a left and right collapsible lines 2a are formed on the middle blocking plate 2 of the observation device 200 so that the middle blocking plate 2 may be collapsed leftward and rightward, and further an up-down collapsible line 5a is formed on the middle of the bottom support frame 5 so that the bottom support frame 5 may be collapsed upward and downward.

Additionally, holes are perforated on both ends of the left and right images 3L, 3R of the leaflet 100, as shown in FIG. 6(a) to form fixing holes 7b, respectively, and further a protrusion member 7a may be formed on an internal face of the fastening unit 7.

Through aforementioned configuration, the observation device 200 moving on a surface of the leaflet 100 may be stopped stably at a desired location of the left and right images 3L, 3R.

Furthermore, according to one embodiment of the present invention, as shown in FIG. 6(a), the observation device 200 provided with the movement frame 6 is movable upward and downward on a rear surface of the leaflet 100, that is, on a three dimension image 1a so that a several three dimension images can be observed.

Meanwhile, as shown in FIG. 6(b), through the left and right collapsible line 2b of the middle blocking plate 2 and the up-down collapsible line 5a of the bottom support frame 5 the respective middle blocking plate 2 and the bottom support frame 5 are collapsed simultaneously to form a thin configuration thereof, as shown in FIG. 6(c). Here, not-indicated reference numerals in FIGS. 6(b) and 6(c) are identical to those in FIG. 6(a). Additionally, a several general advertising faces 1(a) may be added to the front face or rear face of the leaflet 100. In summary, the aforementioned observation device 200 of the present invention, as shown in FIG. 6(a), is configured such that the movement frame 6 and the lens plate 4 may be stand erectly or collapsible based on the bottom support plate 5, if necessary, so that the observation device 200 is movable on surfaces of the left and right images 3L, 3R, causing the several three dimension images are to be observed.

According to one embodiment of the present invention, a three dimension leaflet for advertising a three dimension movie, a three dimension leaflet for advertising precious metals are provided so that three dimension image of motor bicycle, which can not be provided on a conventional plain leaflet, is provided on the three dimension leaflet. Furthermore, three dimension pictures of cars or precious metals, samples of which can not be provided on an advertising leaflet, are provided on the three dimension leaflet, together with conventional advertising wordings wherein a several three dimension pictures are provided three-dimensionally and moved on one three dimension leaflet, increasing commercial advertising effects.

While the present invention is described referring to the preferred embodiment, the present invention is not limited thereto, and thus various variation and modification can be made without departing from a scope of the present invention.

1. A three dimension advertising leaflet for observing several three dimensional images on one leaflet comprising:
a leaflet having a front face of which an advertising surface is provided, and a rear face of which a plurality of left and right images is provided; and
an observation device provided with a lens plate having a middle blocking plate, a bottom support frame and left and right lens, and a movement frame having left and right windows wherein the middle blocking plate, the bottom support frame, and the lens plate support each other, wherein the lens plate and the movement frame are arranged to stand erectly so that the observation device is movable on surfaces of the left and right images.

2. A three dimension advertising leaflet for observing several three dimensional images according to claim 1, further comprises a connection device detachable to both ends of the middle blocking plate and middle parts of the lens plate and the movement frame.

3. A three dimension advertising leaflet for observing several three dimensional images according to claim 1, further comprises stopping holes formed on both ends of the leaflet.

4. A three dimension advertising leaflet for observing several three dimensional images according to claim 1, further comprises several advertising faces provided on front and rear surfaces of leaflet.

5. A three dimension advertising leaflet for observing several three dimensional images according to claim 1, wherein an observation device is provided with a lens plate having a middle blocking plate, a bottom support frame and left and right lens, and a movement frame having left and right windows wherein a left and right collapsible line is provided on the middle blocking plate and an up-down collapsible line is provided on the bottom support frame, and wherein the middle blocking plate is provided on the middle parts of the left and right images and the left and right lens and the leaflet, and wherein the observation device is configured for the middle blocking plate, the bottom support frame and the lens plate to stand firmly, and wherein the observation device is arranged to be connected to the leaflet with a fastening unit, the observation device being movable on a surface of the left and right images so that several three dimension images are observed on one leaflet wherein the lens plate, the middle blocking plate, and bottom support frame are collapsible to form a thin film configuration thereof is possible.
